(19) United States
(12) Patent Application Publication
(10) Pub. No.: US 2007/0080925 A1
(43) Pub. Date: Apr. 12, 2007

(54) Power generating display device

(75) Inventors: Zoran Radivojevic, Helsinki (FI); Jukka I. Rantala, Espoo (FI); Steven O. Dunford, Lewisville, TX (US); Viswanadham Puligandla, Flower Mound, TX (US); Jouko Korppi-Tommola, Saynatsalo (FI); Jani Kallioinen, Jyvaskyla (FI)

Correspondence Address: BANNER & WITCOFF, 1001 G STREET N W, SUITE 1100, WASHINGTON, DC, 20001, US

(73) Assignee: Nokia Corporation, Espoo (FI)

(21) Appl. No.: 11/248,010

(22) Filed: Oct. 11, 2005

(51) Int. Cl. G09G 3/38

(52) U.S. Cl. 345/105

(57) ABSTRACT

Low power consumption display devices are disclosed. Phoactive layers are utilized that both respond to electrical energy to allow a display device to display information and that generate electrical energy in response to incident radiation. Display pixels of a single display device may be divided displaying and generating pixels. The displaying pixels may display information and the generating pixels may generate electrical energy. The generated electrical energy may be used to provide power to drive an image.

### FIELD OF THE INVENTION

This invention relates to electronic displays. More particularly, this invention relates to a system and method for operating an electronic display with minimal or no external electric energy.

### BACKGROUND OF THE INVENTION

Modern electronic devices frequently include display devices. For most people, vision is the most highly-developed sense, and it is expected that important information be communicated in visual form. Even low power consumption display devices, such as liquid crystal display devices, consume a large portion of the power consumed by the electronic devices. The use of portable electronic devices, such as laptop computers, mobile terminals, etc. are limited by the availability of power sources. Portable battery packs are frequently used to provide power to portable electronic devices. Because of the limited life of existing battery packs and the power consumption of display devices, users are required to transport and use multiple battery packs or limit the use of portable electronic devices.

The power consumption requirements of electronic display devices also limits the applications for such devices. For example, a display device that displays promotional material for extended time periods must be located in close proximity to an electrical energy source. Providing electrical energy in some locations can be cost prohibitive and in some cases unsafe. It such situations static billboards or banners are often used even though they lack the flexibility and appearance characteristics of electronic display devices.

Therefore, there is a need in the art for electronic display devices that operate with minimal or no external electric energy.

### SUMMARY OF THE INVENTION

Aspects of the present invention addresses at least some of the needs identified above by providing display devices and methods which employ photoactive layers that are capable of both generating electrical energy and displaying information. Pixels may be selected for generating electrical energy and displaying information, thus eliminating or reducing the need for an external energy supply.

In one embodiment, an autonomous display device is achieved by creating display pixels using TiO₂ nanoparticles with a dye for photon absorption. The tandem functionality of the display pixels is determined by external micro-switches connected to the display pixels which provide an external resistance/voltage. Based on a photoelectrochromic reaction, the pixels having high external resistances (Rₑₓₜ=R_{H}) (an open micro-switch) will be dark or colored under illumination. The rest of the pixels, having low external resistances (Rₑₓₜ=R_{L}) (closed micro-switch) will remain transparent, semi-transparent or slightly colored or become bleached if previously colored. These transparent pixels are used for energy generation. The basic physical properties and conceptual design of the device allow that a formed pattern of dark and transparent pixels can be used to construct an image/text and create energy from the same area (tandem device on the level of a single pixel). Colored pixels serve to create the image/text, while transparent pixels contribute to energy generation. Obtained energy can be stored in a battery/capacitor to provide autonomy of the device operation.

In other embodiments one or more of the disclosed methods may be implemented as computer-executable instructions recorded on a computer readable medium such as a floppy disk or CD-ROM.

A more detailed summary of the invention and exemplary embodiments can be found in the detailed description of the invention.

### BRIEF DESCRIPTION OF THE DRAWINGS

The present invention is illustrated by way of example in the following figures and is not limited by the accompanying figures in which:

FIG. 1 depicts an embodiment of a display-solar cell pixel device.

FIG. 2 depicts the operation principle of a photoelectrochromic device. The substrate can be a glass or flexible and transparent polymer material.

FIG. 3 depicts a direct pixel addressing scheme of an autonomous display device.

FIG. 4 depicts a passive pixel addressing scheme of an autonomous display device.

FIG. 5 depicts the color scheme of a color autonomous display device.

FIG. 6 depicts an embodiment of an autonomous display device system.

FIG. 7 is a flow chart describing one embodiment of operating an autonomous display device system.

### DETAILED DESCRIPTION OF THE INVENTION

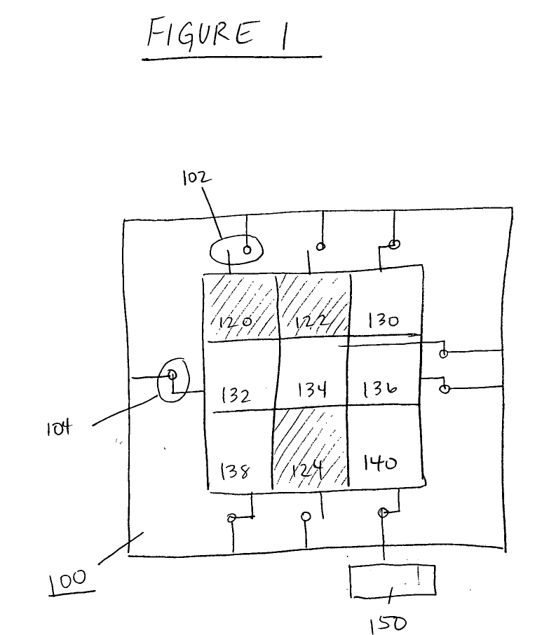

FIG. 1, describing one embodiment of the invention, shows an embodiment of a display-solar cell device which is capable of displaying images and text and generating energy for storing in a battery or for autonomous operation of the display device by determining the scheme of external micro-switches (e.g. external micro-switches 102 and 104). The display-solar cell pixel device of FIG. 1 can be used to achieve an autonomous display device.

The operation of the device can be guided by determining a scheme of external micro-switches 102 and 104 to set a pattern of pixels to show image/text on a device (as schematically depicted in FIG. 1). More precisely, the pixels having high external resistances (Rₑₓₜ=R_{H}) (an open micro-switch) will be dark, semi transparent and/or colored under illumination such as pixel 120. The rest of the pixels, having low external resistances (Rₑₓₜ=R_{L}) (closed micro-switch) will remain transparent, semi-transparent or slightly colored, or become bleached if previously colored such as pixel 132. These transparent pixels (closed micro-switches) are used for energy generation. Alternatively, the dark, semi transparent and/or colored pixels (open micro-switches) are used for energy generation. The basic physical properties and conceptual design of the device allow that a formed pattern of dark and transparent pixels can be used to construct an image and/or text and create energy from the same area (tandem device on the level of a single pixel). Colored pixels 120, 122, and 124 serve to create the image and/or text, while transparent pixels 130, 132, 134, 136, 138, and 140 will contribute to energy generation. Obtained energy can be stored in a small battery or capacitor to provide autonomy of the device operation.

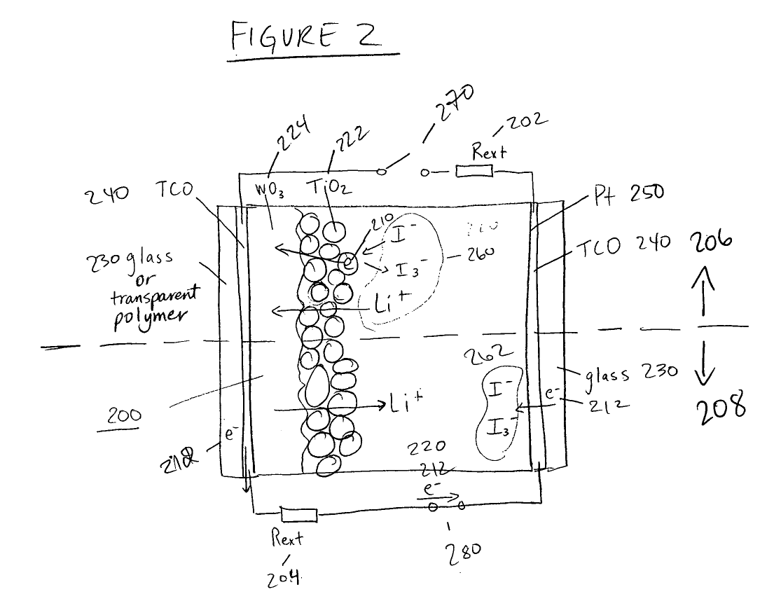

FIG. 2, describing one embodiment of the invention, shows the color change reactions induced by illumination and determined by external resistance (Rₑₓₜ) that can be exploited to implement aspects of the invention which is capable of having two operational modes on the level of single pixel 200. Under illumination, the upper portion 206 shows the coloration in open circuit (high Rₑₓₜ) conditions and the lower portion 208 shows the bleaching in short-circuit (low Rₑₓₜ) conditions. At the microscopic level, the status of external resistance 202 and 204 governs the directional flow of electrons, which in turn determines the mode of operation of single pixel 200. The coloring of a single pixel takes place under high-external resistances (Rₑₓₜ=R_{H}, open-circuit conditions), Rₑₓₜ 202. Electrons 210 are injected from the dye 220 into a conduction band of TiO₂ 222 from where it diffuses into WO₃ 224, where coloration from transparent to dark takes place. In the dark state the color of the single pixel depends on the type of electrochromic material used. In the bleached state the color of the single pixel depends on the light harvesting, sensitizer dye used. The dye can be, for instance, a transition metal complex or an organic molecule. The color may be the visible region from blue to red or in the invisible near-IR region. The bleaching of the device is made under low-external resistance conditions (Rₑₓₜ=R_{L}, short-circuit conditions), Rₑₓₜ 204. Or, in other words, if external resistance is low (Rₑₓₜ=R_{L}) the pixels will be transparent under illumination. At the same time a transparent pixel will generate energy like a solar cell pixel. Therefore, no external power source is needed to color or bleach the device. In addition, the coloration time is independent of the area of the device. This allows construction of relatively small and large pixels (0.1 mm-100 cm in diameter) by the same technology.

The photoactive color change layer of the pixel depicted in FIG. 2 is made up of (from bottom to top) glass or polymer substrate 230, TCO 240, WO₃ 224, TiO₂ 222, dye 220, electrolyte 260, Pt 250, TCO 240, and glass or polymer substrate 230. The photoactive layer (TiO₂ 222/dye 220) and the electrochromic layer (WO₃ 224) are sol-gel deposited, while the thin Pt layer 250 may be sputtered or otherwise deposited on the opposite transparent conductive electrode (TCO 240). Between both electrodes is an electrolyte 260 containing Li⁺ ions and a redox couple (I⁻/I₃⁻). Multiple layers or stacking might be an option especially to increase efficiency of energy generation. The structure may be foldable.

The physical features described in FIGS. 1 and 2 can be utilized as an autonomous tandem display device, capable of performing as a display (for imaging) and as a solar cell (energy generation). When the micro-switch 280 is closed (R_{L} conditions) while the device is illuminated, the electrons 212 are transferred from WO₃ 224 to the Pt electrode 250, causing the regeneration of I⁻ ions in the electrolyte 262. WO₃ is oxidized and the device transmission is not changed (or becomes bleached if the previous state was colored). Furthermore, under this condition (R_{L}) a current is generated which can be directed to charge an external battery or capacitor 150 and accumulate energy for autonomous operation of the whole device. The energy generation can provide enough energy for autonomous operation including micro-switching circuitry (to change or update an image), CPU (to control operation of the device), battery control circuitry (to control charging battery), wireless access to an external device (WLAN, BT, IR to set an image from remote device) and energy for sequential operation of a LED for back lighting purpose (blinking mode to increase attention).

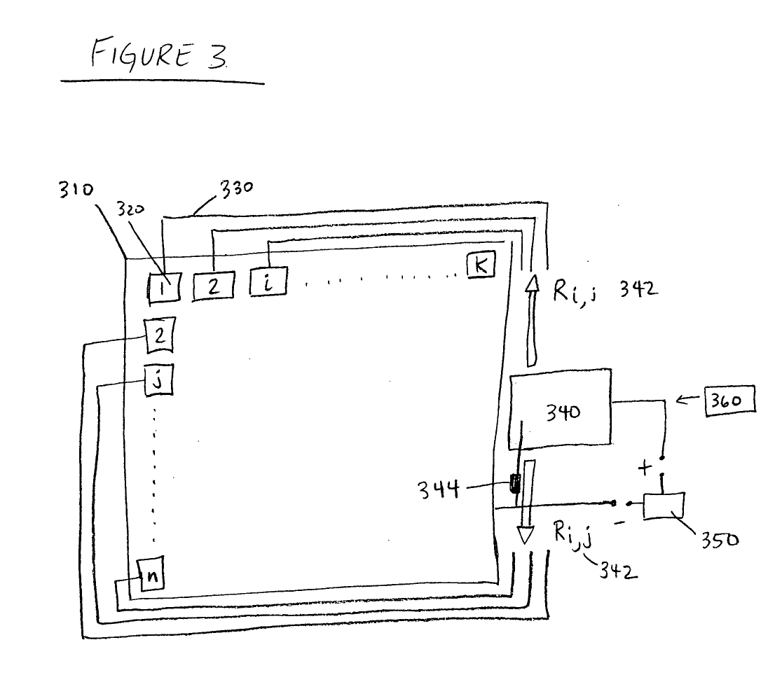

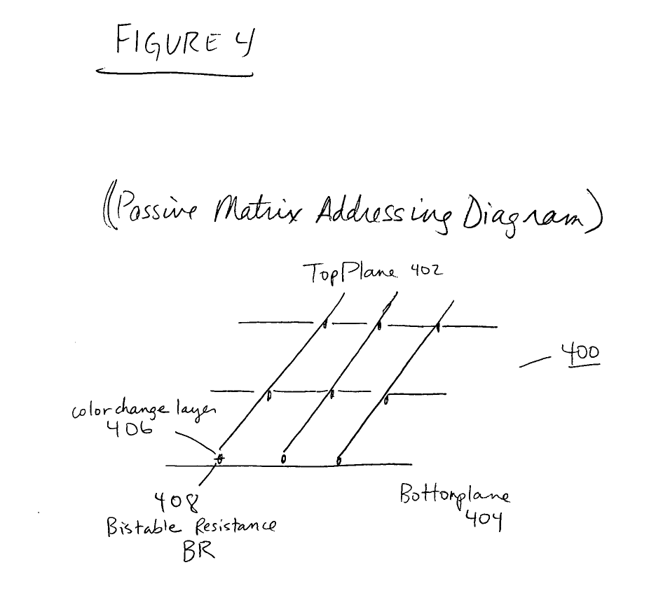

FIGS. 3 and 4 show example pixel addressing schemes of an autonomous display device. The purpose of each addressing scheme is to set the state of the pixel and determine a mode of operation (imaging or energy generation).

Direct Addressing

FIG. 3, describing one aspect of the invention, shows a direct addressing scheme of an autonomous display device. In direct addressing, the display device runs by individual control signals to each pixel, which allows the state, whether dark or transparent, to be set and maintained on each pixel. The top-side 310 (side closer to the source of light) is made as an electrode (TCO). On the bottom-side there is a matrix of TCO pads 330 corresponding to the active area of the pixels. In a direct addressing architecture each pixel is accessed by a single wire 330, which could be as tiny as 50 microns. The routing lines of the wires go around the TCO pads and connect to the bi-stable Micro Switch circuitry (b-MS) 340 that determines external resistances of the each pixel. As described the values of external resistances 342 can be settled as high—R_{H} or low—R_{L}, determining mode of operation of the pixel (colored/transparent, imaging/energy generation). Furthermore, by setting general resistance 344 (R_{G}) to the common electrode (top-side TCO), the overall brightness of the display device can be adjusted. All of the pixels set to have low R_{L} (transparent pixels) are connected and contribute to energy generation and battery or capacitor 350 charging. This energy can be used to provide autonomy of the display device including powering of the bi-stable micro switching circuit (b-MS) itself, an image Setting Drive (ISD) and Wireless Access (WLAN or BT or IR) module.

Passive Matrix Addressing

FIG. 4, describing one aspect of the invention, shows the general scheme of passive matrix addressing (PMA) of an autonomous display device using bi-stable junctions. In general, passive matrix addressing (crossbar-based architecture) have several advantages, such as programmability and the potential for low-cost fabrication and high-device densities. High-density may be required in color embodiments that finction as autonomous display devices. Some novel display technologies use a bi-stable material, which maintains its state for a long period of time without the need for individual transistor elements at each pixel. Exemplary bi-stable materials include polymer stabilized cholesteric liquid crystal materials. By passive matrix addressing, the display device runs control signals only to the rows and columns of the device. For example, for a color screen the size of n×k pixels, a passive matrix addressing scheme would require n+3k control signals, which is less than the number of control signals required with active matrix addressing.

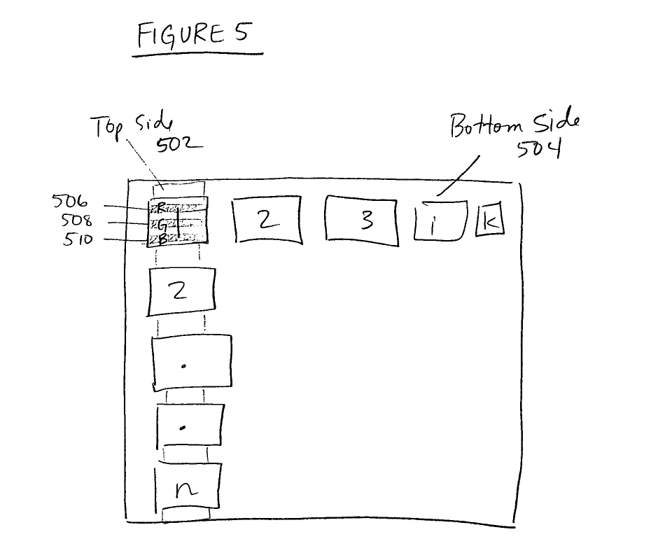

Color versions of an autonomous display device can be realized by combining photoelectrochromic (PEC) reactions, the passive matrix addressing technique and bi-stable resistances 408 embedded in the vicinity of the PEC color change layer 406. FIG. 5, in one embodiment of the invention, shows a passive matrix addressing scheme of a color autonomous display device. For color versions each pixel is composed of three sub-pixels (R-red 506, G-green 508, and B-blue 510) which can be activated individually by PMA technique to create a color image. Physically the color of each sub-pixel (R-G-B) is determined by using different electrochromic material or/and light harvesting dye in the pixel construction. In practice it means different materials are deposited at places of R-G-B sub-pixels. The architecture for determining the mode of operation of each pixel is similar to that of direct addressing. All of the color display pixels having high external resistance R_{H} will be colored and serve the purpose of color image creation while color display pixels with low external resistance R_{L} will stay transparent and contribute to the energy generation process. In passive matrix addressing, when a row and column are activated, only the pixel at the intersection of the row and column is addressed by setting the bistable resistance values to R_{H} (transparent pixel) or R_{L} (colored pixel). In this scheme the whole set of colored pixels can be accessed and its state can be determined by using a relatively low number of external lines and the passive matrix addressing technique.

To provide built-in bi-stability of the color display device, an additional layer of bi-stable resistances is required. In practice this can be achieved by embedding a set of bi-stable micro resistances in the vicinity of the each pixel. Different physical phenomena and materials can be used to construct such programmable and bi-stable resistances. For example, an organic electrical bi-stable device (OBD) can be used at the bottom plane of the color display device to provide bi-stable resistances. Other techniques may be used to exploit bi-stable molecules, electromechanical manipulation of carbon nanotubes or crossed nanowires, ferroelectric materials, liquid crystal materials etc.

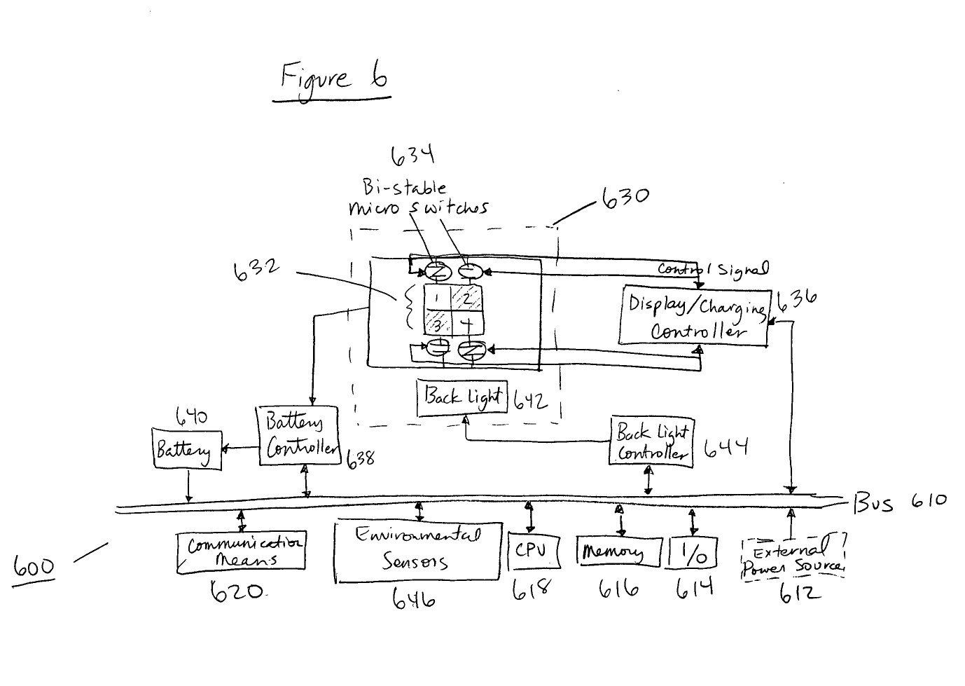

FIG. 6 depicts a simplified block-diagram of one embodiment of a display device 600 utilizing a display-solar cell pixel device 630. The device comprises a bus that connects components to each other 610, an external power source 612 for primary or alternative power source, an I/O means 614, one or more memory units 616 for storing applications needed for running the device and storing data presented on the display, a CPU 618 for controlling the device, one or more communication means 620 for short and long wired and wireless communication, and a display-solar cell pixel device 630. The display-solar cell pixel device further comprises one or more display-solar cell pixels 632, Bi-stable micro switches 634 that are connected to the display-charger controller and to the pixels, a display-charger controller 636 for controlling and powering the pixels for displaying information and charging power, a battery controller 638 for controlling charging the battery in communication with display-charger controller, one or more batteries 640 for storing and delivering power for the device, a back-light 642 for illuminating the display, a back-light controller 644 for controlling the back-light, and one or more environmental sensors 646, such as a light, temperature, or humidity sensor, for delivering environmental information to the system, or an IC providing the real time signals for a clock in a window application (larger clock embedded into house window).

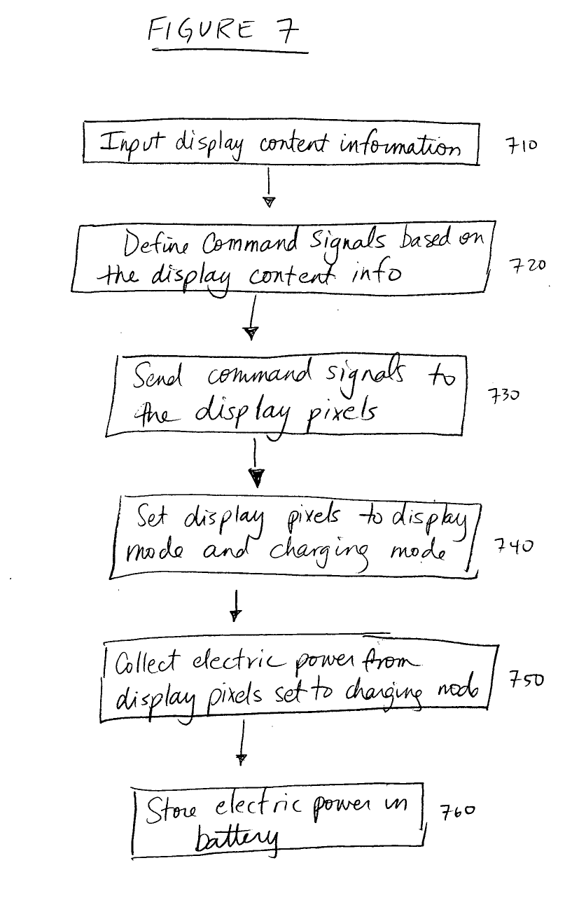

FIG. 7 is a flow-chart describing one embodiment for controlling the display-solar cell pixel device. Specifically, display content information is input from memory or via the communication means from an external source to a display/charging controller (710). The display/charging controller defines command signals based on the display content information so that the content information will be displayed (720). Next, the command signals are sent from the display/charging controller to the display pixels (730). Based on the command signals, some of the pixels are set to a presentation mode and some of the pixels are set to a charging mode (740). Electric power is then collected from the display pixels that are set to charging mode (750) and the electric power is stored by the battery/capacitor (760).

In another embodiment, battery charging information may be used for controlling the display pixels and determining electric power needed for the device functions. More particularly, display content information as well as battery charging information is input to a display/charging controller. The display/charging controller then defines command signals based on the display content information and the battery charging information, and sends the command signals to the display pixels. Based on the command signals, some of the pixels are set to a presentation mode and some of the pixels are set to a charging mode. The display/charging controller may also define and send a second command signal to a back light controller, causing illumination of the back light based on the second command signal. Electric power is then collected from the display pixels that are set to charging mode and the electric power is stored by the battery. Further, the battery charging information may be controlled and inputted in real time. Additionally, when the display is in idle mode it may be used wholly as a solar cell.

In yet other embodiments, input information from environmental sensors (or the real time clock IC, for a clock in a window application) may also be used to control the display of content information and the battery charging function. For example, a light sensor may be used to control back-light illumination. In such an embodiment, display content information, battery charging information, and light sensor data is input to a display/charging controller. The display/charging controller then defines command signals based on the display content information, battery charging information, and light sensor data and sends the command signals to the display pixels. In another embodiment, a clock could be embedded into a housing window which runs on the sunlight. The electronics driving the clock would consist of a real time IC and a large display showing the time in digital or analog form. Based on the command signals (input from sensors or the time IC), some of the pixels are set to a presentation mode and some of the pixels are set to a charging mode. The display/charging controller may also define and send a second command signal to a back light controller, causing illumination of the back light based on the second command signal. Electric power is then collected from the display pixels that are set to charging mode and the electric power is stored by the battery, or partly stored by the battery while simultaneously directing power to the device. Further, battery charging information may be controlled and inputted in real time to the display controller and/or to the time IC.

In yet another embodiment, an external electrical power may be needed to keep up one status of a pixel in active mode. This status may be dark, semi transparent and/or colored, or alternatively transparent, semi-transparent or slightly colored. The other status of the pixel may then still be used as a solar cell.

In yet another embodiment, the display-solar cell pixel device may be implemented in any display, audio or communication device, portable or fixed, such as a video device, a music device, a digital camera, a digital camcorder, a TV set, a lap-top computer, a PDA, a personal communication device, a mobile communication device, a mobile phone, a GPS device, a radio receiver, or a watch. Further, in other embodiments, the electric power from the solar cell pixel device may be stored in the mentioned devices for avoiding charging using an external electric power source, or for extending usage time before recharging of a battery using an external electric power source.

In yet another embodiment, the display-solar cell pixel device may be implemented in windows, for example in vehicles and buildings. In some cases it is useful to darken the windows, i.e. at least part of the pixels, for sun shade and at the same time to use another part of the pixels as solar cells. In some cases, decorative ornaments may be displayed.

In yet another embodiment, the display-solar cell pixel device may be implemented in digital advertising billboards, digital cost labels, information panels, traffic signs, or traffic lights.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims. For example, various solar cell photoactive layers are described and one skilled in the art will appreciate that aspects of the invention may be implemented with device that generate electrical energy in response to the exposure of electromagnetic radiation outside of the visible spectrum.

We claim:

1. A display device comprising:
a photoactive layer;
a first set of pixel electrodes configured to apply an electric field to the photoactive layer and change at least one light transmission characteristic of corresponding sections of the photoactive layer; and
a second set of pixel electrodes configured to harness electrical energy produced by sections of the photoactive layer that absorb radiation and produce electrical energy.

2. The display device of claim 1, wherein the photoactive layer comprise bi-stable electrochromic material.

3. The display device of claim 2, wherein the bi-stable electrochromic material comprises nanocrystalline metal oxide (e.g. WO₃).

4. The display device of claim 2, wherein the bi-stable electrochromic material comprises nanocrystalline metal oxide (e.g. titanium dioxide, TiO₂) with electron acceptor molecules.

5. The display device of claim 1, further comprising:
a display charger controller for controlling and powering the first set and the second set of pixel electrodes; and
at least one communication means for wired or wireless communication.

6. The display device of claim 5, further comprising one or more environmental sensors for delivering environmental information to the display charger controller.

7. The display device of claim 5, further comprising:
a display light; and
one or more batteries for storing the electrical energy.

8. The display device of claim 7, further comprising:
a battery controller for controlling charging the one or more batteries in communication with the display charger controller; and
a display light controller for controlling the display light.

9. The display device of claim 5, further comprising micro-switches connected to the display charger controller and to the one or more pixels electrodes.

10. A display device comprising one or more display pixels, wherein the display pixels are configured to selectively display information and generate electricity.

11. The display device of claim 10, wherein the display pixels comprise bi-stable electrochromic material.

12. The display device of claim 11, wherein the bi-stable electrochromic material comprises nanocrystalline metal oxide (e.g. WO₃).

13. The display device of claim 11, wherein the bi-stable electrochromic material comprises nanocrystalline metal oxide (e.g. titanium dioxide, TiO₂) with an electron acceptor molecule.

14. The display device of claim 10, further comprising a display charger controller for controlling and powering the display pixels;

15. The display device of claim 14, further comprising one or more environmental sensors for delivering environmental information to the display charger controller.

16. The display device of claim 14, further comprising:
one or more batteries for storing the electrical energy; and
a battery controller for controlling charging the one or more batteries in communication with the display charger controller.

17. The display device of claim 14, further comprising micro-switches connected to the display charger controller and to the one or more pixels electrodes.

18. The display device of claim 17, wherein the micro-switches may be selectively open to provide high external resistance, or closed to provide low external resistance.

19. A mobile terminal comprising:
a processor;
a bus for connecting components within the mobile terminal;
a display comprising one or more display pixels, wherein the display pixels are configured to selectively display information and generate electricity; and
a memory for storing data presented on the display.

20. The mobile terminal of claim 19, wherein the display pixels comprise bi-stable electrochromic material.

21. The mobile terminal of claim 20, wherein the bi-stable electrochromic material comprises nanocrystalline metal oxide (e.g. WO₃).

22. The mobile terminal of claim 20, wherein the bi-stable electrochromic material comprises nanocrystalline metal oxide (e.g. titanium dioxide, TiO₂) with an electron acceptor molecule.

23. A method of operating a display device, comprising:
(a) inputting display information to a display controller;
(b) defining command signals based on the display information so that the display information can be displayed on the display device;
(c) sending the command signals from the display controller to one or more display pixels;
(d) displaying the display information on the one or more display pixels based on the command signals; and
(e) collecting electric power from the one or more display pixels based on the command signals.

24. The method of claim 23, step (b) further comprising:
(i) setting one or more display pixels to a display mode based on the command signals; and
(ii) setting one or more display pixels to a charging mode based on the command signals.

25. The method of claim 23, further comprising storing the collected electric power in a battery.

26. A method of operating an autonomous display device, comprising:
(a) inputting display information to a display charger controller;
(b) inputting battery charging information to the display charger controller;
(c) defining command signals based on the display information and the battery charging information;
(d) sending the command signals from the display charger controller to one or more display pixels;
(e) displaying the display information on the one or more display pixels based on the command signals; and
(f) collecting electric power from the one or more display pixels based on the command signals.

27. The method of claim 26, step (c) further comprising:
(i) setting one or more display pixels to a display mode based on the command signals; and
(ii) setting one or more display pixels to a charging mode based on the command signals.

28. The method of claim 26 further comprising:
(g) defining one or more second command signals;
(h) sending the second command signals from the display charger controller to a display light controller; and
(i) illuminating the display light based on the second command signals.

29. The method of claim 27, further comprising:
(g) storing part of the collected electric power and directing part of the collected electric power to the display device.

30. The method of claim 27, further comprising:
(g) controlling the battery charging information.

31. The method of claim 27, further comprising:
(g) defining one or more second command signals based on light sensor data from one or more environmental sensors;
(h) sending the command signals based on light sensor data to the display charger controller; and
(i) controlling one or more light sensors base on the light sensor data.
